(19) United States
(12) Patent Application Publication
(10) Pub. No.: US 2008/0246654 A1
(43) Pub. Date: Oct. 9, 2008

(54) METHOD AND AN APPARATUS TO ASSIST USER BACK TO PREVIOUS LOCATION

(76) Inventor: Ming Cheng, East Brunswick, NJ (US)

Correspondence Address: WALTER J. TENCZA JR., 100 Menlo Park, Suite 210, Edison, NJ, 08837, US

(21) Appl. No.: 11/697,753

(22) Filed: Apr. 9, 2007

(51) Int. Cl. G01S 3/02

(52) U.S. Cl. 342/357.06; 342/451; 342/457; 345/418; 704/231

(57) ABSTRACT

A device is provided, which uses a positioning system, to determine a first geographic location, while the device is located at the first geographic location. Information concerning the first geographic location may be stored in a computer memory. The device may be moved from the first geographic location to a second geographic location which is substantially different from the first geographic location. The device may be used to determine the second geographic location, while the device is located at the second geographic location. Information concerning the second geographic location may be stored in a computer memory. Directions from the second geographic location to the first geographic location may be provided by the device to a user. The directions may be displayed on a computer monitor or provided orally by use of a voice system.

### FIELD OF THE INVENTION

This invention relates to improved methods and apparatus concerning

### BACKGROUND OF THE INVENTION

Global Positioning Satellite devices or receivers can determine their current position by use of a GPS system. The GPS system used may be that provided by the United States or a GPS system provided by other countries such as Galileo provided by the European Union. GPS positioning is based on a number of orbiting satellites that broadcast signals to GPS receivers. The signals may include the identity and position of the satellites that broadcast the signal. The signal may also include the time when the signals were broadcast. A GPS receiver may use this information to calculate its position, including its latitude, longitude and altitude.

### SUMMARY OF THE INVENTION

One or more embodiments of the present invention provide a handheld GPS device that can provide directions to a user. In one embodiment a GPS device can assist users in locating their vehicle at a parking lot.

The user can use a handheld GPS device to calculate and save the calculated location information for later use. In particular, after the user parks his vehicle at a parking lot, he or she can use the GPS device to calculate and save the vehicle position at the spot. Later on after he or she, is done shopping, he or she can use the typically handheld GPS device to guide him or her back to their vehicle.

At least one embodiment of the present invention provides a method, comprising using a device, which uses a positioning system, to determine a first geographic location, while the device is located at the first geographic location. The method may also include storing, in a memory, such as an electronic memory or computer memory, information concerning the first geographic location. The method may further include moving the device from the first geographic location to a second geographic location which is substantially different from the first geographic location, using the device to determine the second geographic location, while the device is located at the second geographic location. Information concerning the second geographic location may be stored in a computer memory. Directions from the second geographic location to the first geographic location may be provided by the device to a user. The directions may be displayed on a computer monitor or provided orally by use of a voice system. The device may be a handheld device. The computer memory may be a handheld device electronic, computer, or microprocessor memory. The monitor may be a handheld device monitor or display such as used with a computer, microprocessor, or other electronic circuitry. Embodiments of the present invention may be applied to handheld devices such as devices from Garmin (trademarked) or GPS capable mobile telephones from Verizon Wireless (trademarked).

### BRIEF DESCRIPTION OF THE DRAWINGS

FIG. 1 shows a simplified diagram of a Global Positioning Satellite (GPS) device in a first state;

FIG. 2 shows a simplified diagram of a Global Positioning Satellite (GPS) device in a second state;

FIG. 3 shows a simplified diagram of a Global Positioning Satellite (GPS) device in a third state; and

FIG. 4 shows a diagram of components of the GPS device.

### DETAILED DESCRIPTION OF THE DRAWINGS

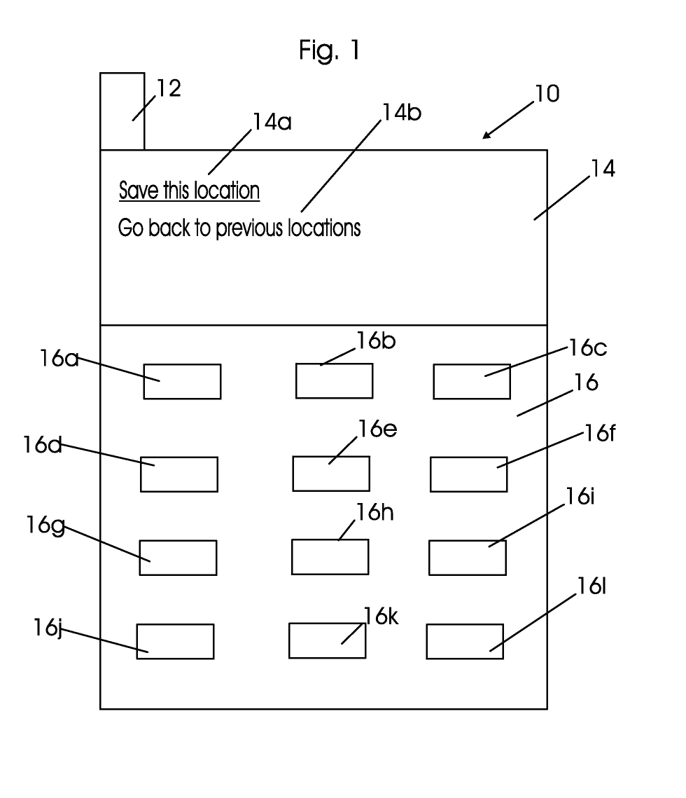

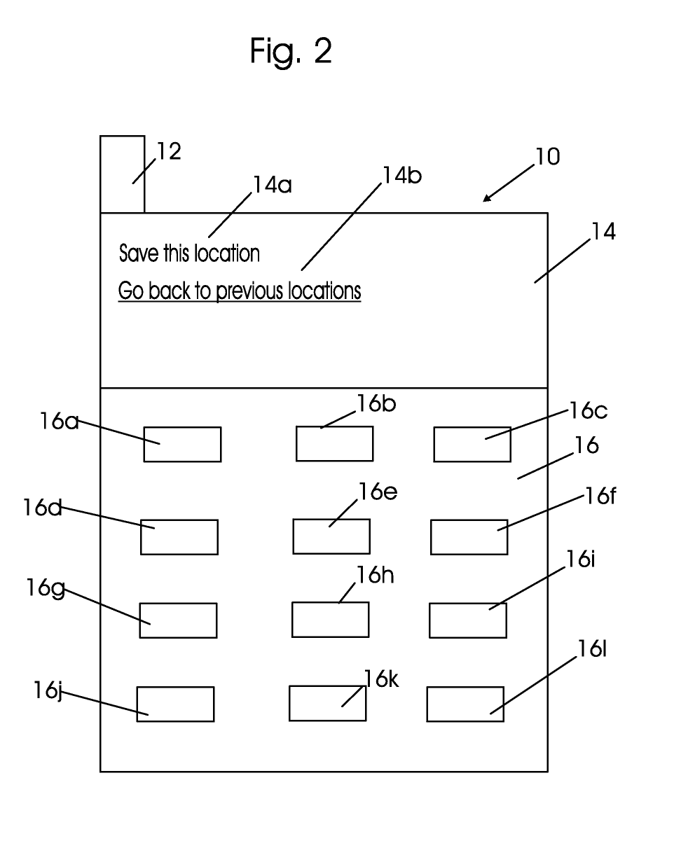

FIGS. 1-3 show simplified diagrams of a Global Positioning Satellite (GPS) device 10 in first, second, and third states, respectively. The GPS device 10 includes an antenna 12, a screen or computer monitor 14, and a keypad 16. The keypad 16 includes keys or buttons 16a-16l, which may include typical keys such as on a telephone keypad, such as the numbers 1-9, 0, *, and #. As on a telephone keypad, each of the numbers may have a series of letters associated with it. For example, the number 2 may have the letters “ABC” associated with it, and printed along with the number 2, on the key or button 16b. The GPS device 10 may include a GPS mobile telephone.

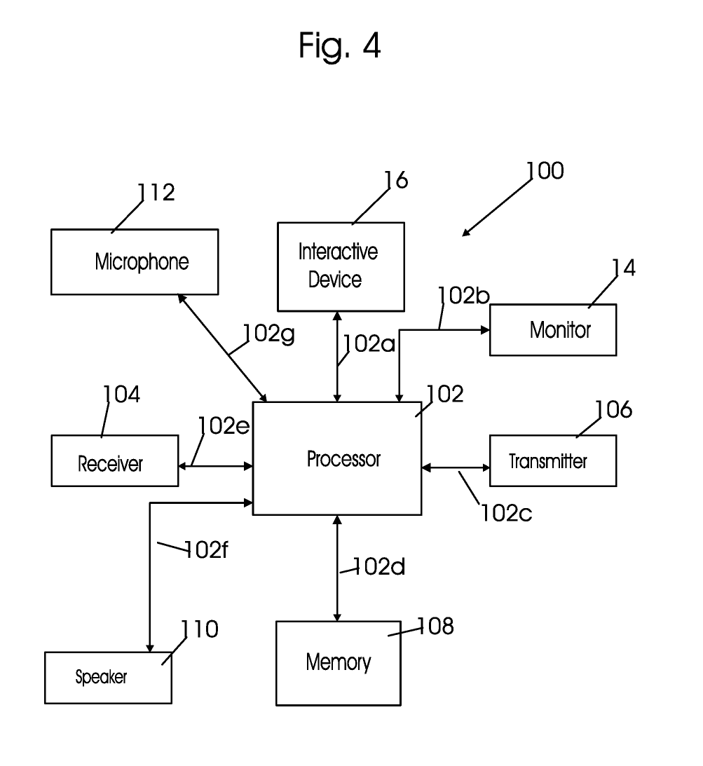

FIG. 4 shows a diagram of components 100 of the GPS device 10. The GPS device 10 includes a processor 102, a computer monitor or display 14, a receiver 104, a transmitter 106, a memory 108, a speaker 110, a microphone 112, and an interactive device 16. Communication links 102a, 102b, 102c, 102d, 102e, 102f, and 102g connect the processor 102 to the interactive device 16, the monitor 14, the transmitter 106, the memory 108, the receiver 104, the speaker 110, and the microphone 112, respectively. The memory 108 may be computer memory. The processor 102 is typically a computer processor.

In FIG. 1, messages and/or fields 14a and 14b are shown on the monitor or display 14. Field 14a states “Save this location” and field 14b states “Go back to previous locations”. A user can select either field 14a or field 14b by hitting one or more of the keys of keypad or interactive device 16. For example, hitting the key 16a may select the entry or field 14a for “Save this location”, while hitting the key 16b may select the entry or field 14b for “Go back to previous locations”. The fields 14a and 14b may be menu items on a handheld device's display or monitor, such as monitor 14.

If field 14a is selected for “Save this location”, the processor 102 calculates and saves the current location of the GPS device 10 in memory 108 using GPS information. The current location may include the current latitude, longitude, and altitude of the GPS device 10.

If field 14b is selected for “Go back to previous locations”, then the processor 102 will cause all previous stored locations in memory 108 to be displayed on the screen or monitor 14. If there are too many stored locations to be displayed, then the user can scroll through them using one or more of the keys of keypad or interactive device 16. Typically, the latitude, longitude, and altitude of the previous stored locations will be displayed although additional information can be displayed.

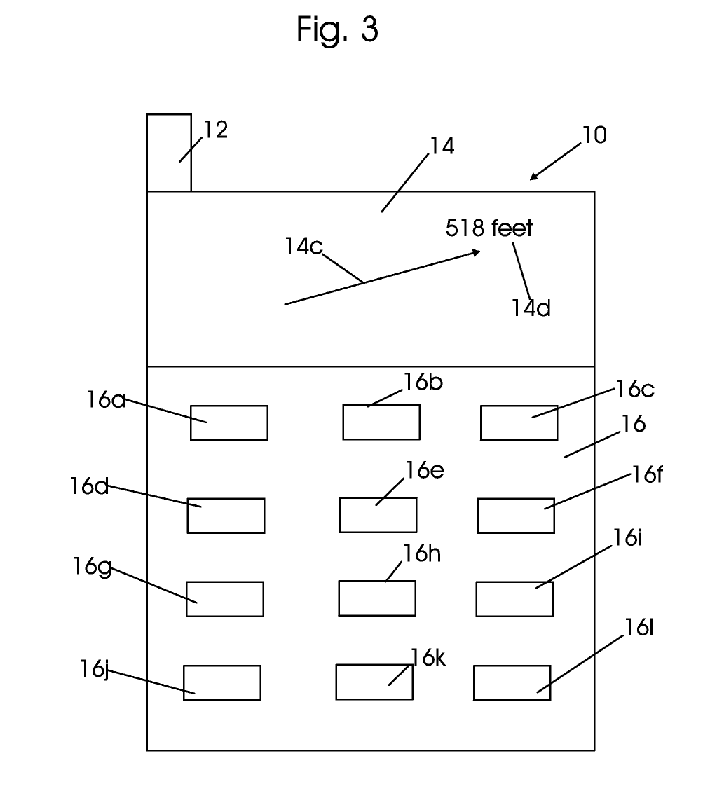

The user can then select one of the previous locations displayed on the monitor 14 and the processor 102 will calculate its current location using GPS information, and calculate the direction and distance between the current location and the previously saved target location. Then the processor 102 will cause a graph of a line with an arrow to be displayed along with a distance, as shown in FIG. 3. The line with the arrow, such as 14c in FIG. 3, shows the direction the user must go in order to get from the current location back to the previous location. The distance shown, such as 14d, which in this case is 518 feet, is the distance from the current location back to the previous location selected. The graph in FIG. 3 guides the user back to the previous spot. In one embodiment of the present invention, the current location, the direction and distance between the current location and the previously saved target location are calculated continuously, by the processor 102 while the user is moving such that the FIG. 3 image on the monitor 14 will be updated continuously. This means that if the user is moving towards the previous location, the distance will continuously decrease until the user reaches the location. If the user moves in the same direction, the line with the arrow 14c will stay the same, and if the user moves in a different direction, the line with the arrow will change orientation.

The method described is in particular useful for assisting a user to get back to his vehicle in a parking lot after shopping at a large shopping mall. After the user parked his car, he can save the vehicle's location by select the field 14a in FIG. 1. In particular, if the GPS device 10 also contains a remote keyless vehicle entry circuit, as part of processor 102, capable of sending out a signal via transmitter 106 to lock the doors of a vehicle, the location of the car may be automatically saved in memory 108 while locking the car. Then after shopping, the user can be guided back to his or her vehicle using a method as described with reference to FIGS. 1-4.

The GPS device 10 can also include a voice system and a voice recognition system. The voice system, may include the processor 102. The processor 102 may be programmed to cause all previous saved locations to be “spoken” out via speaker 110, to a user of GPS device 10, in response to selection of a field, such as field 14b of FIG. 1. The voice recognition system or processor 102, will typically recognize the user's instructions, through microphone 112, concerning which previous locations the user wants to return to. The voice system may then speak out, via speaker 110, the direction and distance to the previous location to assist the user moving back to the target location. This can be used to help vision impaired person to move around different locations.

Although the invention has been described by reference to particular illustrative embodiments thereof, many changes and modifications of the invention may become apparent to those skilled in the art without departing from the spirit and scope of the invention. It is therefore intended to include within this patent all such changes and modifications as may reasonably and properly be included within the scope of the present invention's contribution to the art.

I claim:

1. A method, comprising:
using a device, which uses a positioning system, to determine a first geographic location, while the device is located at the first geographic location;
storing, in a computer memory, information concerning the first geographic location;
moving the device from the first geographic location to a second geographic location which is substantially different from the first geographic location;
using the device to determine the second geographic location, while the device is located at the second geographic location;
storing in a computer memory, information concerning the second geographic location;
and providing directions from the second geographic location to the first geographic location.

2. The method of claim 1 wherein
the device uses a global positioning system.

3. The method of claim 1 wherein
an automobile is located at the first geographic location.

4. The method of claim 1 wherein
the device includes a GPS capable mobile telephone.

5. The method of claim 1 wherein
the device is a handheld device.

6. The method of claim 1 wherein
the device includes a remote keyless vehicle entry circuit for locking and unlocking a vehicle;
and the first geographic location is a geographic location of the vehicle.

7. The method of claim 6 wherein
the device determines the first geographic location automatically and stores the information concerning the first geographic location automatically when a user locks the vehicle using the remote keyless entry circuit.

8. The method of claim 1 wherein
the device includes a voice system and a voice recognition system.

9. The method of claim 8 wherein
the voice recognition system recognizes oral instructions from a user human being concerning which selected one of a plurality of stored geographic locations the user human being wants to return to; and
wherein the voice system speaks out a direction and a distance to the selected one of the plurality of stored geographic locations.

10. The method of claim 1 wherein
the directions are provided by displaying them on a computer monitor.

11. The method of claim 10 wherein
the directions are provided by displaying on the computer monitor a line with an arrow pointing from the second geographic location to the first geographic location, and by displaying on the computer monitor a distance between the first geographic location and the second geographic location.

12. An apparatus comprising
a device including
a computer processor;
a computer memory;
and a receiver;
wherein the processor is programmed to use a positioning system, to determine a first geographic location, while the device is located at the first geographic location;
wherein the processor is programmed to cause information concerning the first geographic location to be stored in the computer memory;
wherein the processor is programmed to use the positioning system, to determine a second geographic location, while the device is located at the second geographic location, the second geographic location substantially different from the first geographic location;.
wherein the processor is programmed to cause information concerning the second geographic location to be stored in the computer memory; and
wherein the processor is programmed to provide directions from the second geographic location to the first geographic location.

13. The apparatus of claim 12 wherein
the positioning system used by the processor is a global positioning system.

14. The apparatus of claim 12 wherein
an automobile is located at the first geographic location.

15. The apparatus of claim 12 wherein
the device includes a GPS capable mobile telephone.

16. The apparatus of claim 12 wherein
the device is a handheld device.

17. The apparatus of claim 12 wherein
the device includes a remote keyless vehicle entry circuit for locking and unlocking a vehicle.

18. The apparatus of claim 17 wherein
the processor is programmed to determine the first geographic location automatically and store the information concerning the first geographic location automatically when a user locks the vehicle using the remote keyless entry circuit.

19. The apparatus of claim 12 wherein
the device includes a voice system and a voice recognition system.

20. The apparatus of claim 19 wherein
the voice recognition system recognizes oral instructions from a user human being concerning which selected one of a plurality of stored geographic locations the user human being wants to return to; and
wherein the voice system speaks out a direction and a distance to the selected one of the plurality of stored geographic locations.

21. The apparatus of claim 11 further comprising
a computer monitor;
and wherein the directions are provided by displaying them on the computer monitor.

22. The apparatus of claim 21 wherein
the directions are provided by displaying on the computer monitor a line with an arrow pointing from the second geographic location to the first geographic location, and by displaying on the computer monitor a distance between the first geographic location and the second geographic location.
